(19) United States
(12) Patent Application Publication
(10) Pub. No.: US 2004/0257825 A1
(43) Pub. Date: Dec. 23, 2004

(54) Light emitting device for use in vehicle wheel

(76) Inventors: Nakim Choi, Seoul (KR); Jeongwoo Choi, Suh-gu (KR)

Correspondence Address: SHERIDAN ROSS PC, 1560 BROADWAY, SUITE 1200, DENVER, CO, 80202

(21) Appl. No.: 10/644,885

(22) Filed: Aug. 19, 2003

(30) Foreign Application Priority Data
Jun. 18, 2003 (KR) 10-2003-0039359

(51) Int. Cl. B60Q 1/26

(52) U.S. Cl. 362/500

(57) ABSTRACT

The present invention relates to a light emitting device for use in a wheel which induces the generation of electricity using a rotary power due to rotation of the axle and induces the lighting using the electric power thus induced. In general, the vehicle wheel is installed at both sides of the vehicle body and tires are attached to the wheels, respectively. Regardless of the materials of the wheel, all the wheels are attached to and detached from the axle by fastening means. However, all the light emitting devices for use in a wheel usually employ the power of the vehicle or an additional battery. For this reason, there is a significant limitation in the use. According to the present invention, the lighting is induced by the generation of electricity due to a rotary power of the wheel so that the power can be stably supplied and the lighting can be accomplished when the vehicle is traveling.

### BACKGROUND OF THE INVENTION

1. Field of the Invention

The present invention relates to a light emitting device for use in a wheel, which is mounted to an axle to which the wheel is attached while being located outside the vehicle wheel, and more particularly, to a light emitting device for use in a wheel which induces the generation of electricity using a rotary power due to rotation of the axle and induces the lighting using the electric power thus induced.

2. Background of the Related Art

In general, vehicle wheels are installed at both sides of the axle. Tires are attached to the wheels. The wheels are usually attached to and detached from the axle by means of fastening means.

Accordingly, in order to attach/detach the wheel to/from the axle, a nut is needed. Further, an additional cover plate is typically used in order to prevent exposure of the nut to the outside.

Such a cover plate, however, has only a covering function. In order to overcome this functional limitation, an effort for making the cover plate have a new function needs to be made.

Furthermore, a headlight is usually turned on when a vehicle is traveling at night. The headlight is installed to usually shine on toward the front only. In the case where the vehicle is turned right and left with the headlight turned on, the sides of the vehicle are relatively dark compared to the front thereof. Due to this, every driver would have thought that it is inconvenient in the traveling at night.

In addition, as increasing peoples use a vehicle to enjoy various leisure activities, the vehicle is used as one of decoration means. The vehicle is thus variously decorated.

Therefore, an attempt has recently been made to induce the lighting of the wheel so as to secure decorability of the vehicle and stability in the driving. However, this is accomplished by only the lighting means using the vehicle battery.

Such lighting means, however, is not effective due to discharge of the battery that may occur by the use of the vehicle power source and a structural problem that this power source is connected to the wheel so as to be turned on.

In order to solve the above-mentioned shortcomings, there exists an effort to induce the lighting using an additional battery. However, this method has problems in that there is a need for an additional storage space to contain the battery and the battery must be frequently replaced due to its short life span.

It may be considered to use the rotary power of the wheel in order to generate electricity. However, it is required that a magnetic line of force be orthogonally interlinked to the coil for the generation of electricity, which causes a problem in that it is difficult to be substantially commercialized.

### SUMMARY OF THE INVENTION

Accordingly, the present invention has been made in view of the above problems, and it is an object of the present invention to provide a light emitting device for use in a vehicle wheel, which make an electric current flowing into a coil wire as a magnetic line of force is orthogonally interlinked to the coil while the coil assembly is rotated, by not allowing a cover unit to which a permanent magnet is mounted to rotate upon the lighting by the rotary force of the wheel and the rotation of the wheel for the lighting.

To accomplish the above object, according to the present invention, there is provided a light emitting device for use in a vehicle wheel, comprising: a support plate having assembly grooves formed on the outer peripheral surface thereof so as to be mounted to fastening means through which a wheel is attached to an axle; a body coupled to the support plate, and having a circuit board connected to a coil of a coil assembly and a light-emitting element mounted on the circuit board, the body having openings formed on the outer peripheral surface thereof in such a manner as to correspond to assembly grooves of the support plate for the assembly of the body with the axle; and a cover unit mounted to the outer side of the body by means of a shaft and having a permanent magnet assembly built therein, whereby when the wheel is rotated, the cover unit is not rotated.

Such lighting makes the right and left sides of the vehicle shone on during the traveling at night, thus contributing to a safe driving.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view illustrating the assembly process of a light emitting device for use in a vehicle wheel according to the present invention,

FIG. 2 is a cross-sectional view illustrating a state where the light emitting device is assembled according to the present invention,

FIG. 3 is a perspective view illustrating a state where the light emitting device is mounted to the vehicle wheel, and

FIG. 4 is a perspective view illustrating a state where the light emitting device is mounted to the wheel according to another embodiment of the present invention.

### DETAILED DESCRIPTION OF THE PREFERRED EMBODIMENT

The present invention will now be described in detail in connection with preferred embodiments with reference to the accompanying drawings, in which like reference numerals are used to designate the same or similar parts although they are shown in different drawings.

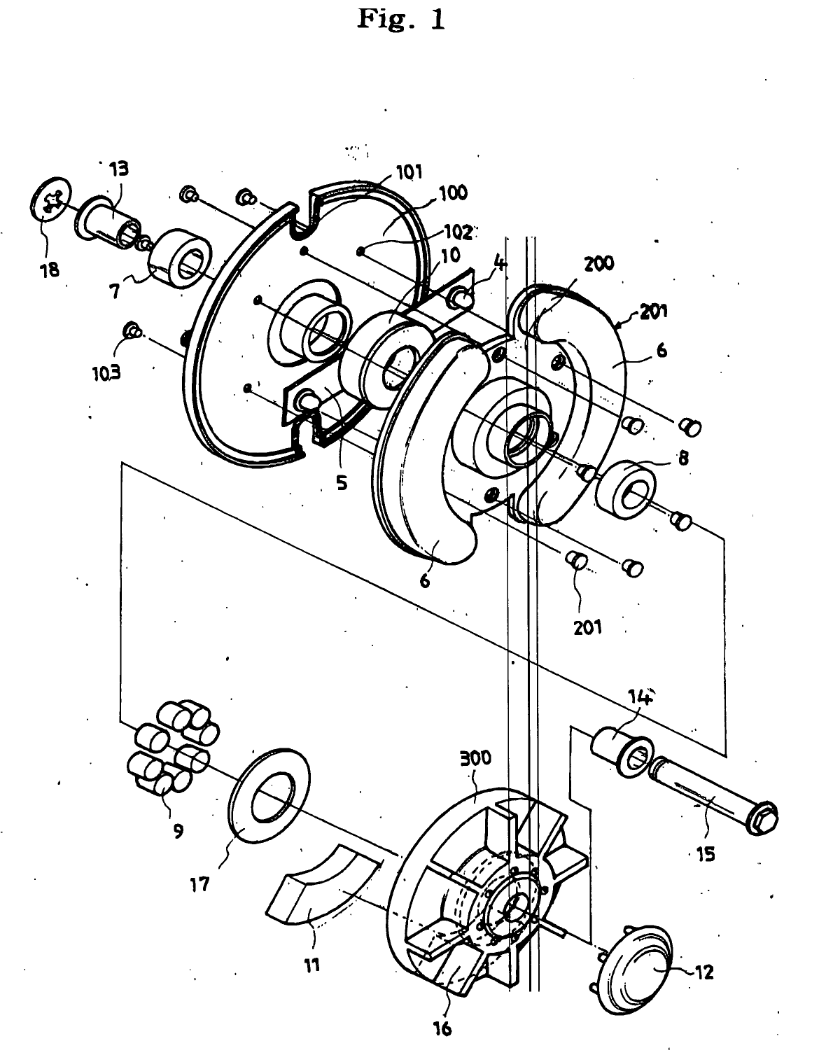

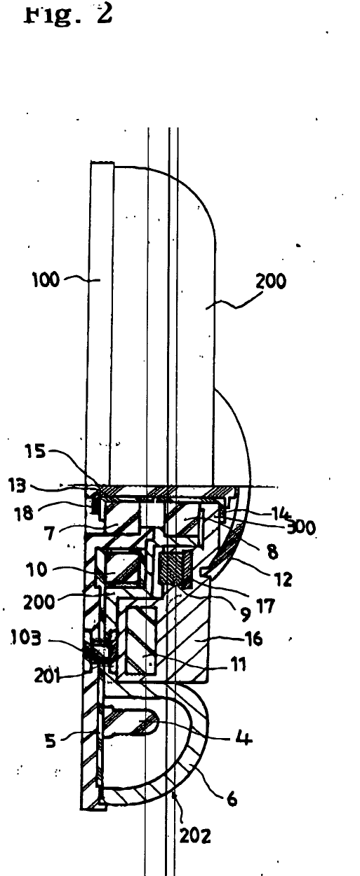

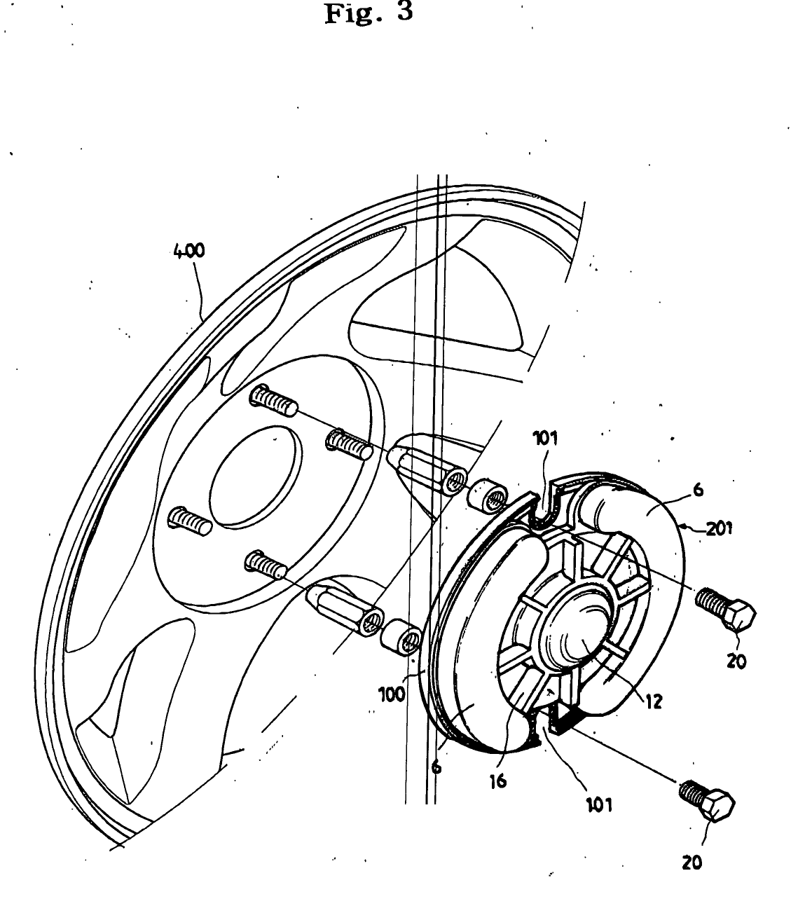

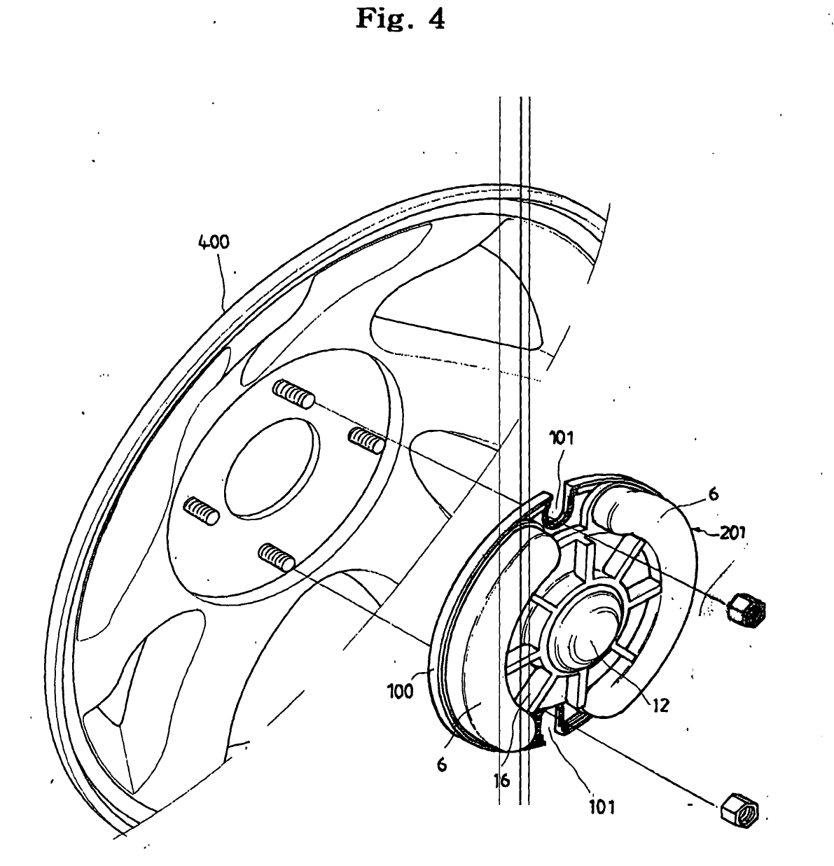

FIG. 1 is a dismantled perspective view illustrating the assembly process of a light emitting device for use in a vehicle wheel according to the present invention, FIG. 2 is a cross-sectional view illustrating a state where the light emitting device is assembled according to the present invention, FIG. 3 is a perspective view illustrating a state where the light emitting device is mounted on the vehicle wheel and FIG. 4 is a perspective view illustrating a state where the light emitting device is mounted to the wheel according to another embodiment of the present invention.

The construction of the light emitting device for use in a vehicle wheel according to the present invention will be described hereinafter.

The light emitting device includes a support plate 100 mounted to fastening means 500 through which a wheel 400 is attached to an axle, a body 200 coupled to the support plate 100 by means of fastening male screws 103 and fastening female screws 201, and having a circuit board 5 connected to a coil (not shown) of a coil assembly 10 and a light emitting element 202 mounted on the circuit board 5, and a cover unit 300 that is mounted to the outer side of the body 200 by means of a shaft 15 and having a permanent magnet assembly 9 built therein.

At this time, the support plate 100 and the body 200 are coupled to the fastening means 500 of the axle by means of fastening nuts 501, etc., through assembly grooves 101 of the support plate 100 with the support plate 100 and the body 200 tightly sealed. The nuts 501 are formed in a longitudinal direction and are then fixed by additional fastening bolts 20.

In the case where the support plate 100 and the body 200 are coupled to each other, the coil assembly 10 is attached to the circuit board 5 within the body 200. A light-emitting element 4 is attached to both sides of the circuit board 5. The light-emitting element 4 is thus turned on by the current flowing into the coil (not shown) of the coil assembly 10.

At this time, a transparent cover element 6 of the body 200 is protruded from surface of the body by a given height so that the light-emitting element 4 can be positioned therewithin. It should be noted that this protrusion may have various shapes.

Furthermore, the coil assembly 10 in which the coil (not shown) is wound is inserted into a hollow protrusion 6a that is protruded from the central portion of the body 200 for a stable fixture to the body 200.

In addition, openings 6b are formed at both sides of the transparent cover element 6 of the body 200 coupled to the support plate 100 for the purpose of the assembly of the body 200 with the axle.

Therefore, the body 200 coupled to the support plate 100 is coupled to the axle 500 that is rotating, thereby having the same rotary power to the wheel 400. On the contrary, the cover unit 300 attached to the outer side of the body 200 has the magnet assembly 9 formed therein. Thus, in order for the current to flow into the coil assembly 10, it is required that the cover unit 300 is not rotated. To this end, the shaft 15 must be inserted into shaft holes 19c and 19b of the support plate 100 and the body 200 after passing through a shaft hole 19a of the cover unit 300. At the same time, a snap ring 18 must be coupled to a stopping rim 20 formed at the front end of the shaft 15. At this time, bearings 7 and 8 are inserted into the shaft holes 19c and 19b of the support plate 100 and the body 200, respectively. Thus, by means of the bearings 7 and 8, the support plate 100 and the body 200 are easily rotated along with the wheel but the cover unit 300 does not rotate.

At this time, in order to facilitate the rotation, additional shaft caps 13 and 14 may be mounted to the bearings 7 and 8.

Further, as a supplement means for preventing the cover unit from rotating, an eccentric weight 11 is installed at the inner bottom of the cover unit 300, so that the weight center due to the eccentric weight 11 is placed downwardly so that the cover unit 300 is prevented from rotating.

At this time, in order for a magnetic line of force of to orthogonally interlink the coil at a large amount, the coil assembly 10 is inserted into the hollow protrusion 6a of the body 200. Accordingly, a protrusion portion 301 is formed at the central portion of the cover unit 300 for inserting the magnet assembly 9 thereto such that the hollow protrusion 6a is inserted to the inner side of the central protrusion portion 301 to couple the cover unit 300 to the body 200. In such a coupling state, the eccentric weight 11 is mounted at the lower portion of the cover unit 300. With this structure, the cover unit 300 can be always maintained in a fixed state without rotating.

Furthermore, anti-rotation blades 16 are formed the outer surface of the cover unit 300 in such a manner as to extend radially outwardly from the outer periphery of the central protrusion portion 301, for preventing the rotation of the cover unit 300 in the driving direction of the wheel through the resistance of the air.

A cap 12 is coupled to the outer side of the cover unit 300 into which the shaft 15 is inserted. Thus, the shaft 15 coupled to the cover unit 300 is concealed by the cap 12, but not exposed to the outside.

Therefore, as the axle is rotated when the vehicle is traveling, the support plate and the body are simultaneously rotated by the rotation of the wheel. At this time, the cover unit is not rotated by the shaft and is not further rotated by the eccentric weight.

Accordingly, as the coil assembly 10 is rotated, the magnetic line of force generated from the permanent magnetic assembly 9 is orthogonal to the coils of the coil assembly. Current flows into the coil so that the light-emitting element is turned on.

At this time, the circuit board has a rectifying means for the generation of the current in order to stably supply the current. Therefore, light shines beautifully during the vehicle's traveling. Since the lighting is accomplished by this rotary power, there occurs no such problem as consumption of the battery in the vehicle like in the prior art.

As described above, the light-emitting device is installed to the wheel of the vehicle, so that a driver in one vehicle can easily visible to drivers of other vehicles or pedestrians even at night or a dark place. Therefore, the present invention has advantages in that it can prevent a traffic accident and makes the external appearance of the vehicle beautifully decorated.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A light emitting device for use in a vehicle wheel, comprising:
a support plate having assembly grooves formed on the outer peripheral surface thereof so as to be mounted to fastening means through which a wheel is attached to an axle;
a body coupled to the support plate, and having a circuit board connected to a coil of a coil assembly and a light-emitting element mounted on the circuit board, the body having openings formed on the outer peripheral surface thereof in such a manner as to correspond to assembly grooves of the support plate for the assembly of the body with the axle; and
a cover unit mounted to the outer side of the body by means of a shaft and having a permanent magnet assembly built therein,
whereby when the wheel is rotated, the cover unit is not rotated.

2. The light emitting device as claimed in claim 1, wherein the assembly grooves are of a ∪ shape.

3. The light emitting device as claimed in claim 1, wherein the support plate and the body are coupled to the fastening means of the axle by means of fastening nuts and fastening bolts through assembly grooves of the support plate with the support plate and the body tightly sealed.

4. The light emitting device as claimed in claim 1, wherein the light-emitting element is contained in a transparent cover element formed on the body.

5. The light emitting device as claimed in claim 1, wherein the coil assembly is inserted into a hollow protrusion that is protruded from the central portion of the body for a stable fixture to the body.

6. The light emitting device as claimed in claim 1, wherein the shaft is inserted into shaft grooves of the support plate and the body after passing through a shaft groove of the cover unit, and a snap ring is coupled to a stopping rim formed at the front end of the shaft, so that when the support plate and the body rotate along with the wheel, the cover unit is not rotated.

7. The light emitting device as claimed in claim 1, wherein an eccentric weight is installed at an inner bottom of the cover unit so that the weight center due to the eccentric weight is placed downwardly, thereby preventing the cover unit from rotating.

8. The light emitting device as claimed in claim 1, wherein a cap is coupled to the outer side of the cover unit into which the shaft is inserted, so that the shaft coupled to the cover unit is concealed by the cap, but not exposed to the outside.

9. The light emitting device as claimed in claim 4, wherein the transparent cover element has a concave-convex surface for scattering light.

10. The light emitting device as claimed in claim 6, wherein bearings are inserted into the shaft holes of the support plate and the body, respectively, and by means of the bearings, the support plate and the body are easily rotated along with the wheel but the cover unit does not rotate.

11. The light emitting device as claimed in claim 6, wherein an additional shaft cap is attached to the shaft.

12. The light emitting device as claimed in claim 5, wherein the coil assembly is inserted into the hollow protrusion of the body, and a protrusion portion is formed at the central portion of the cover unit for inserting the magnet assembly thereto, and at the same time, such that the hollow protrusion is inserted to the inner side of the central protrusion portion to couple the cover unit to the body.

13. The light emitting device as claimed in claim 12, wherein anti-rotation blades are formed the outer surface of the cover unit in such a manner as to extend radially outwardly from the outer periphery of the central protrusion portion, for preventing the rotation of the cover unit in the driving direction of the wheel through the resistance of the air.
